(19) United States
(12) Patent Application Publication
(10) Pub. No.: US 2009/0025579 A1
(43) Pub. Date: Jan. 29, 2009

(54) METHOD AND SYSTEM FOR IMPROVED PLASTIC COMPACTOR BAGS

(75) Inventor: Trent H. Mallory, Southlake, TX (US)

Correspondence Address: AKIN GUMP STRAUSS HAUER & FELD, LLP, P O BOX 688, DALLAS, TX, 75313-0688, US

(73) Assignee: Poly-America, L.P., Grand Prairie, TX (US)

(21) Appl. No.: 11/781,395

(22) Filed: Jul. 23, 2007

(51) Int. Cl. B30B 9/30

(52) U.S. Cl. 100/229 A

(57) ABSTRACT

A method and system for improved plastic compactor bags is provided by the present invention. In particular, the present invention discloses a method of using plastic compactor bags having flaps for use with a compactor, such that the plastic flapped bag with two or more flaps is placed into the container of a compactor having a front panel in close proximity to the container. The flaps of the plastic compactor bag are provided such that a person installing the bag can pull the plastic bag over an upper edge of the container to facilitate securing the plastic flapped compactor bag onto the container of the compactor. Furthermore, the present invention discloses a system of a plastic flapped compactor bag placed within a container of a compactor. Finally, the present invention discloses a method of removal of a plastic flapped compactor bag from a container of a compactor.

### CROSS REFERENCE TO RELATED APPLICATIONS

Not applicable.

### BACKGROUND OF THE INVENTION

1. Field of the Invention

The present disclosure relates to products constructed from plastic sheets, in particular plastic bags for compactors. In particular, the present disclosure relates to providing flapped plastic bags for compactors to facilitate installation of the plastic compactor bags in the receptacle basin, or container, of compactors and removal of the plastic compactor bags from the same.

2. Description of the Related Art

Plastic bags are generally manufactured using a blown-film extrusion process which comprises forming a blown-film tube from polyethylene or other polymeric materials, flattening the blown-film tube, and forming a set of seals and/or cuts in the blown-film tube to form a plurality of plastic bags from the blown-film tube. When manufacturing bags using the blown-film extrusion process, a tubular film is formed with air blown through the center of the tube as heated molten plastic is extruded through a die on the extrusion machine. The resulting tubular film is of substantially uniform thickness around the entire circumference of the film. A pair of nip rollers pulls the blown-film up and the film cools as it continues to be pulled upward. As the film cools, it can eventually be flattened and processed into various types of bags or other plastic products.

There are various types of plastic bags on the market, available in capacities ranging from a few gallons up to 50 gallons or more. Furthermore, plastic bags are available with particular features, especially with respect to the method of tying, or securing, the bag after it is filled. Some plastic trash bags have straight-cut openings which are generally bunched together and tied with a string or metal wire to hold the contents of the bag after the bag is filled. Another type of plastic trash bag is the drawstring-type plastic trash bag that features a plastic drawstring embedded along the upper opening, or collar, of the plastic trash bag. When the trash bag is filled with debris, the drawstring can be pulled tight through two openings in the collar of the plastic bag, thereby closing the top of the trash bag. The two portions of the drawstring can then be tied together to close the upper opening of the trash bag.

Another type of trash bag, most relevant to the present invention, is the wave-cut plastic trash bag. These trash bags feature two or more waves extending upward from the opening of the plastic bag. When the trash bag is filled with debris or other contents, the waves of the bags may be tied together to secure the contents of the bag inside. In the prior art, the focus of wave-cut, plastic trash bags has been on the closure of the bags. As will be seen with respect to the present invention, a four-flapped bag provides numerous advantages when used with under-the-counter compactors in the home or office that until now have gone unrecognized.

Compactors are used in various industries to reduce the sheer volume of waste material and products. In large industrial applications, compactors are used to compact industrial waste into smaller volumes for hauling or storage. By decreasing the volume of a particular amount of waste, the frequency and cost of hauling the trash away can be significantly reduced. Compactors in kitchens of homes and offices offer similar advantages on a smaller scale, allowing a container of a particular capacity to hold a greater quantity of compacted trash, resulting in less frequent trips to empty the trash.

Traditional kitchen trash bags are typically 13 gallons in capacity and are not the most suitable solution for use in home compactors as the size of the bags does not match the compactor's container. Therefore, consumers generally rely on special types of paper and plastic compactor bags that specifically address the unique issues affecting compactors. The paper compactor bags are usually folded flat for transportation and sale, and opened to fit within the container of the compactor. Liquids are often present in the container, so it is necessary to provide a plastic coating, or other liquid-impermeable layer, to the interior of the paper compactor bag to prevent leakage of the paper bag if exposed to the liquids. The necessity of the coating layer and the generally higher costs associated with paper bags result in paper compactor bags that are typically markedly more expensive than plastic bags, including plastic compactor bags.

As an alternative to paper compactor bags, specialty plastic compactor bags are available. The commercially available plastic compactor bags are similar to ordinary kitchen bags, except the bag is markedly thicker and generally larger than ordinary kitchen bags. The opening of the specialty plastic compactor bag is straight while the length of the bag is such that the top of the bag extends slightly over the top edge of the container, allowing the top of the bag to fold a few inches over the upper lip of the container. However, as discussed subsequently, installation of the plastic compactor bags is not a straight-forward or facile endeavor. The external surface of compactors is also generally not smooth. The ridged and pointed protrusions of the exterior of the container require the bag to be especially durable and tough, which helps to explain why plastic compactor bags are typically over 2.5 times thicker than typical plastic kitchen bags.

Compactors are frequently installed in small spaces in the kitchen of a home or office. Accordingly, compactors are designed to maximize the capacity of the container for a given footprint. Therefore, the containers are generally rectangular and attached to a pair of roller rails mounted near the bottom of the compactor. The roller rails allow the container to slide in and out of the compactor housing. A front panel is secured at the end of the roller rails extending vertically, to provide a front panel that is flush with the surrounding cabinetry when the compactor is in a closed configuration. To maximize utilization of the space, the spacing between the front panel and the container is often extremely small, on the order of one centimeter or less. This extremely small clearance makes installation of plastic bags extremely difficult, as it is particularly challenging to pull the top of the bag over the container and pull it down into the extremely small area between the container and the front panel. Thus, installation of plastic compactor bags as known in the prior art often results in bruised or scraped knuckles and fingers when attempting to secure the bag onto the container.

It would be advantageous to provide a plastic compactor bag which could be easily installed on the container of the compactor. In particular, it would be advantageous to provide a bag that allows a person to install the bag over the upper lip of the compactor and in between the small clearances between various parts of the compactor.

Another impediment to using compactor bags is the difficulty in getting the bag in and out of the compactor. One solution known in the prior art is to use a “caddy” to hold the plastic bags. The caddy is a metal frame or other rigid structure located within the container to facilitate removal of a trash bag from the structure. It would be advantageous to provide an apparatus and method for facilitating the removal of plastic bags filled with trash out of the container of a compactor. In particular, it would be advantageous to provide an apparatus and method for easily removing a plastic bag from the container of a compactor that does not require the use of an additional component, such as a caddy.

### SUMMARY OF THE INVENTION

The present disclosure is described primarily with reference to flapped plastic bags for compactors. However, it is recognized that other types of bags may offer similar advantages. Therefore, the present invention is not limited to the embodiments described herein. Rather, the embodiments described herein illustrate several preferred ways of practicing the invention, but a person having ordinary skill in the art would instantly recognize the advantage of applying these techniques to other types of plastic bags having similar properties. Accordingly, the claims herein are intended to more fully encompass the scope of invention.

The present disclosure is directed toward providing a flapped plastic compactor bag having two or more flaps for the container of a compactor. In one embodiment of the present invention, the front panel of the compactor is in extremely close proximity to the container making it difficult to securely fasten an ordinary plastic compactor bag onto the container without significant difficulty. Flaps of the plastic compactor bag are used to pull the bag over the upper lip, or opening, of the container such that the flapped plastic bag is secured onto the container of the compactor.

According to another embodiment of the present disclosure, a compactor is provided with a container and a front panel in extremely close proximity to the container wherein a plastic compactor bag having at least two flaps is placed within the container. The flaps of the plastic compactor bag extend outward from an upper opening of the container and are used to pull the plastic bag over the upper rim of the container and between the container and the front panel of the compactor.

### BRIEF DESCRIPTION OF THE DRAWINGS

A full and complete understanding of the present disclosure may be obtained by reference to the detailed description of the invention when viewed with reference the accompanying drawings.

FIG. 1A provides a perspective view of a typical commercially-available compactor for a home or office with a specialty plastic compactor bag installed in the container as is known in the prior art.

FIG. 1B provides an elevation view of a typical commercially-available compactor for a home or office with a specialty plastic compactor bag installed in the container as is known in the prior art.

FIG. 2 illustrates a flapped plastic compactor bag according to an embodiment in the present invention, placed within the container of a compactor.

FIG. 3A provides an overhead view of the plastic compactor bag having flaps within a container of a compactor according to the present invention.

FIG. 3B provides a perspective view of the container of a compactor and the plastic flapped compactor bag being secured over the edges of the container, according to the present invention.

FIG. 3C provides an elevation view of the plastic flapped compactor bag properly installed on a container of a compactor.

FIG. 4A provides a perspective view of the plastic flapped compactor bag filled with contents ready for removal from the container of a compactor.

FIG. 4B provides a perspective view of the plastic flapped compactor bag being pulled out for removal from the container of a compactor.

FIG. 4C provides a perspective view of the plastic flapped compactor bag as used within the present invention, securely tied and ready for removal.

### DETAILED DESCRIPTION OF THE INVENTION

The present disclosure illustrates various embodiments of the present invention. In view of the disclosure of the invention contained herein, a person having ordinary skill in the art will recognize that innumerable modifications and insubstantial changes may be incorporated or otherwise included within the present invention without diverging from the spirit of the invention. Therefore, it is understood that the present invention is not limited to the embodiments disclosed herein. The appended claims are intended to encompass the invention to the fullest extent possible, but it is fully appreciated that limitations on the use of particular terms is not intended to conclusively limit the scope of protection for a particular application.

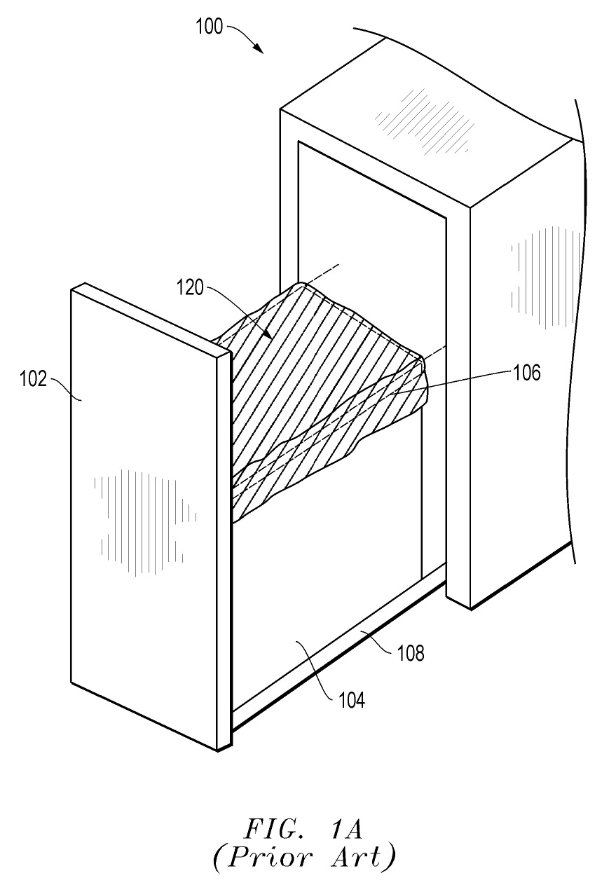

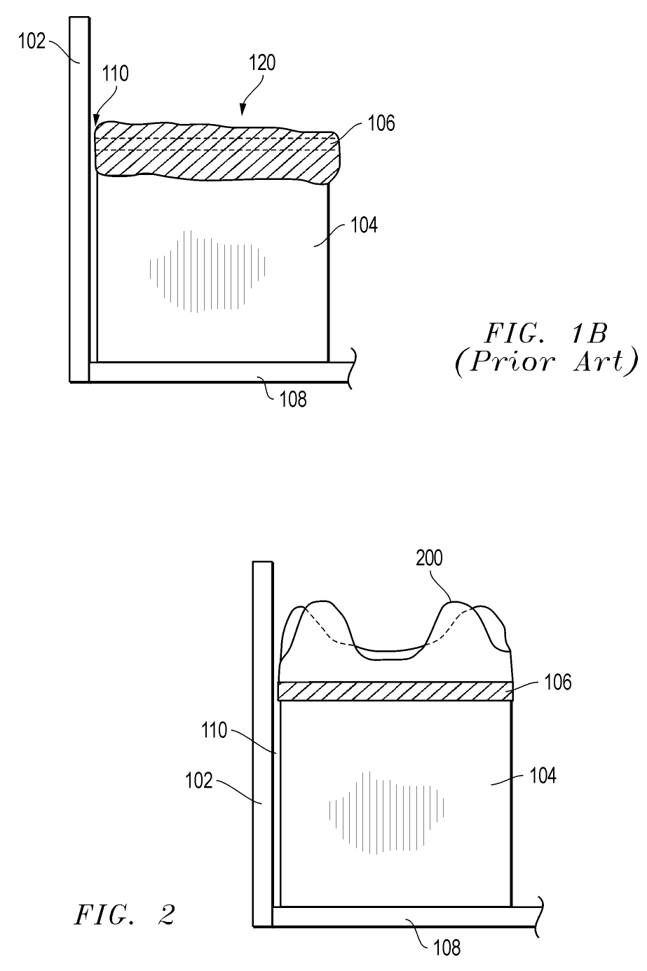

Referring now to FIG. 1A, a commercially-available compactor system 100 is shown as is known in the prior art. The compactor has a front panel 102. The compactor system 100 features a container 104 for holding the compactor bag and trash. In this example, as in many commercial applications, the container 104 of a compactor system 100 will have a plurality of ridges 106 along the upper lip of the container 104 which makes it difficult to put a compactor bag in the container because it further decreases the gap between the front panel 102 and the container 104. The container 104 and the front panel 102 are provided on a pair of rails 108. The rails 108 are located at the bottom of the container 104 and the front panel 102 and allow the container to slide in and out of the housing of the compactor system 100, such that the front panel 102 will fit flush with the surrounding cabinetry.

The compactor system 100 includes all of the necessary mechanical workings and control devices of the compactor, including the actual compacting mechanism. However, embodiments of the present disclosure do not depend on the actual mechanisms or devices used to accomplish the compacting. Therefore, the present disclosure does not address such mechanisms, as a person having ordinary skill in the art would understand that the particular control and compaction mechanisms do not affect the operation of the methods and system disclosed herein.

Referring now to FIG. 1B, an elevation view of the container 104, rails 108, and front panel 102 is shown to illustrate the relationship between the container 104 and the front panel 102. Although the drawing is not precisely to scale, it illustrates the extremely small gap 110 provided between the container 104 and the front panel 102. This gap 110 is often on the order of one centimeter or less.

FIG. 1B also illustrates a traditional plastic compactor bag 120 as known in the prior art installed onto the container 104. As can be seen in FIG. 1B, the traditional plastic compactor bag 120 extends over the upper lip or edge of the container 104 and folds down over the sides of the container 104. These traditional plastic compactor bags 120 are made of relatively thick plastic and do not stretch easily under normal operating conditions. The traditional plastic compactor bags 120, when folded over the edge of the container 104, are generally secured on the container 104 by the rigidity provided by the thickness of the bag 120. However, there is extreme difficulty in getting the traditional plastic compactor bag 120 onto the container 104. This extreme difficulty naturally results from the small gap 110 between the front panel 102 and the container 104. Specifically, it is particularly difficult to get the traditional plastic compactor bag 120 down into the gap 110 between the container 104 and the front panel 102. It is therefore common to scrape and/or bruise knuckles and fingers when attempting to pull the traditional plastic compactor bag 120 over the upper edge of the container 104.

Referring now to FIG. 2, a plastic flapped compactor bag 200 is provided for the container 104 of a compactor according to embodiments of the present invention. In particular, it depicts a plastic flapped compactor bag 200 placed within the container 104. Additionally, the container 104 features a ridge 106 along the upper edge of the container 104, along the exterior of the opening defined by the container 104.

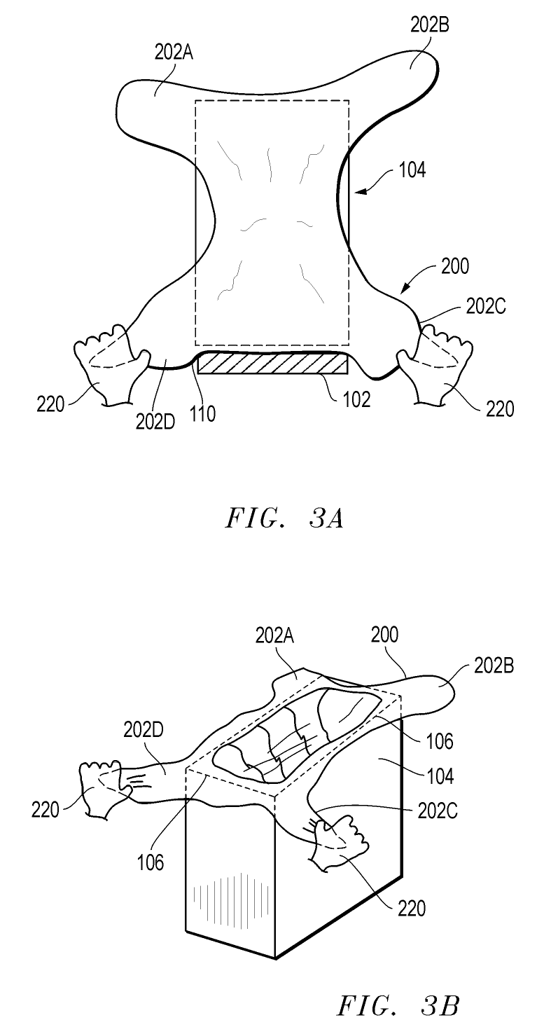

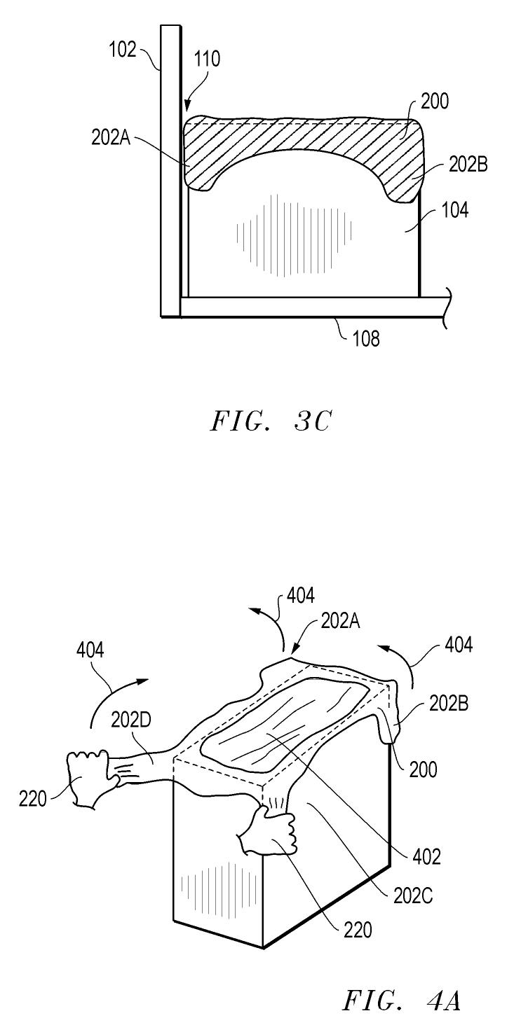

Looking next at FIG. 3A, an overhead view of the installation process is provided. The plastic flapped compactor bag 200 has four flaps 202A, 202B, 202C, and 202D and is placed into the container 104. A person 220 grabs the front two flaps 202C and 202D and pulls the flaps tight around the edges of the container in the small area 110 between the container 104 and front panel 102. Although not shown, the other two flaps 202A and 202B may be pulled around the other corners of the container to secure the bag 200 onto the container 104.

Looking now at FIG. 3B, the front panel is omitted so it can be better seen that the person 220 can pull the two front flaps 202C and 202D so that the plastic flapped compactor bag 200 is pulled over the lip of the container 104. Therefore, according to the present method the person can install the plastic flapped compactor bag 200 without bumping, bruising or scraping his or her knuckles or fingers on either the front panel 102 (depicted in FIG. 3A) or the container 104. FIG. 3C shows the final result with the flaps 202B and 202C of the flapped plastic compactor bag 200 hanging down, with the bag 200 secured onto the container 104.

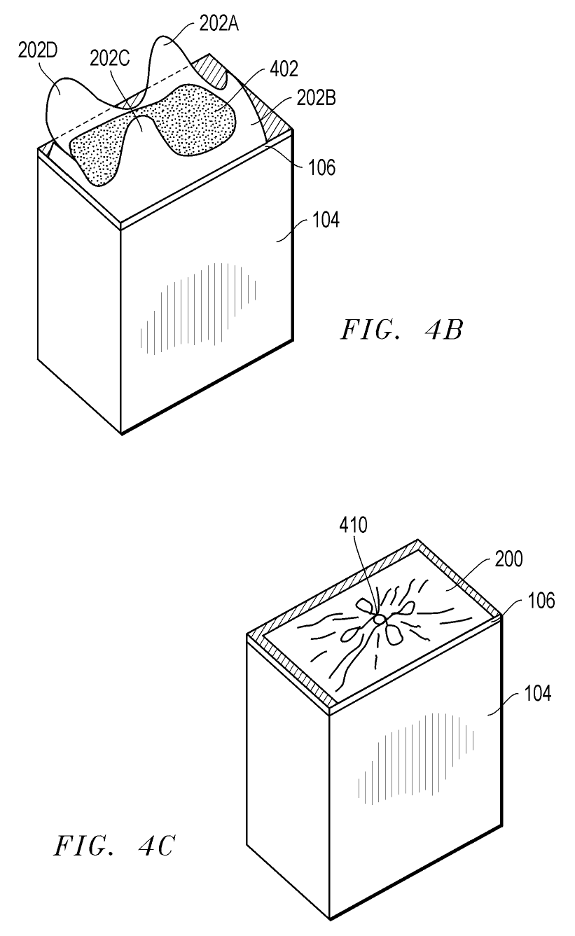

Embodiments of the present invention also teach the removal of the plastic flapped compactor bag 200, without the use of a caddy or any other special devices, as seen in FIGS. 4A, 4B, and 4C. In FIG. 4A, a plastic flapped compactor bag 200 is depicted full of contents 402, particularly household trash and other debris. To remove the bag 200 and its contents 402, a person 220 need only grab the front two flaps 202C and 202D (which are much easier to grab than the plastic between the backed edges and the front panel of a compactor when the prior art non-flapped plastic compactor bag is used) and pull them upward as shown by arrows 404. A similar process is performed with respect to the other two flaps 202A and 202B. FIG. 4B depicts the four flaps 202A, 202B, 202C, and 202D of the bag pulled upward. Thereafter, the opposing sets of flaps are tied together to secure the contents of the bag. Specifically, flaps 202A and 202C are brought together and tied as are flaps 202B and 202D. As seen in FIG. 4C, the flaps 202A, 202B, 202C, and 202D have all been tied 410, facilitating the removal of the bag 200 from the container 104.

1. A method for providing a plastic compactor bag in a compactor, comprising the steps of:
providing a compactor having a front panel and a container, wherein the front panel is in close proximity to the container, and wherein the container defines an upper edge;
providing a plastic compactor bag, wherein the plastic compactor bag has a first flap and a second flap, and wherein both the first flap and second flap extend from an opening of the plastic compactor bag; and
placing the first flap of the plastic compactor bag over a first end of the upper edge and placing the second flap of the plastic compactor over a second end of the upper edge.

2. The method of claim 1, wherein the
container is rectangular in shape and comprises at least one corner.

3. The method of claim 1, wherein the plastic compactor bag is a flapped plastic bag.

4. The method of claim 2, further comprising the step of:
pulling the first flap of the plastic compactor bag over a first corner of the at least one corner of the container;
and pulling the second flap of the plastic compactor bag over a second corner of the at least one corner of the container.

5. The method of claim 2, wherein the plastic compactor bag comprises a third flap and a fourth flap, wherein both the third flap and the fourth flap extend from the opening of the plastic bag.

6. The method of claim 5, further comprising the step of:
pulling the third flap of the plastic compactor bag over a third corner of the at least one corner of the container; and
pulling the fourth flap of the plastic compactor bag over a fourth corner of the at least one corner of the container.

7. The method of claim 1, further comprising the step of:
removing the plastic compactor bag by pulling upward on the provided flaps.

8. A system for providing a plastic compactor bag in a compactor, comprising:
a compactor having a container and a front panel, wherein the front panel is located in close proximity to the container, and wherein an opening of the container defines an upper edge; and
a plastic compactor bag having at least a first flap and a second flap extending from an opening of the plastic compactor bag, the plastic compactor bag placed within the container, and wherein the first flap of the plastic compactor bag extends over a first end of the upper edge and the second flap of the plastic compactor bag extends over a second end of the upper edge.

9. The system of claim 8, wherein the container is rectangular in shape and comprises at least one corner.

10. The system of claim 9, wherein the first flap is pulled over a first corner of the at least one corner of the container and the second flap is pulled over the second corner of the at least one corner of the container.
